(19) United States
(12) Patent Application Publication
(10) Pub. No.: US 2006/0282868 A1
(43) Pub. Date: Dec. 14, 2006

(54) SYOR system

(76) Inventor: Roy Pinney, Fort Lauderdale, FL (US)

Correspondence Address: Roy Pinney, 515 SW 14th Court, Fort Lauderdale, FL, 33315, US

(21) Appl. No.: 11/418,728

(22) Filed: Jul. 28, 2006

Related U.S. Application Data
(63) Continuation-in-part of application No. 10/734,709, filed on Dec. 11, 2003.

(51) Int. Cl. H04N 7/173; H04N 7/16

(52) U.S. Cl. 725/112; 725/113; 725/110; 725/135

(57) ABSTRACT

The INVENTOR'S SYSTEM hereafter referred to as (“my invention”) is an invention of Roy Pinney. My invention is a marketing program, composed of both hardware and software. It provides a consumer with advertising—supported stereo audio and video (with stereo audio) entertainment from around the world. The invention includes my sponsor's (purchaser/licensee of the invention) original audio and video programming content (infomercials). These are designed to sell and promote the sponsor's goods and services. The audio and video (with stereo audio) programming is delivered from the Internet via the consumer's home computer. It is wirelessly sent to his/her home stereo system and television set.

### CROSS-REFERENCE TO RELATED APPLICATIONS

This is a continuation in part of Utility Pat. 11/418,728 (Filing Date: May 5, 2006); Ser. No. 10/734,709 (Filing Date: Dec. 11, 2003).

The SYOR system—An advertising-supported, Internet based, audio and video (with stereo audio) portal web site, which wirelessly sends its signals to the consumer's home stereo system and/or television set.

What is claimed:

1. The SYOR System Kid's CompuView: This feature enables parents to see and hear (on their SYOR System HDTV) what their children are doing on the Internet. They can “drop in” on a child's computer activity whenever they want to, without the child's knowledge, regardless of the computer's location in the home. The adult simply clicks a button on the TV's remote control without getting up from the couch. According to the National Center for Missing & Exploited Children, one out of five children who use the Internet has been propositioned by an adult for illicit activities. How can concerned parents monitor their children's Internet activity? Kid's Compuview. This new claim can be marketed by the company which purchases my invention as a valuable tool on the frontline of protecting children who use the Internet.
The SYOR System Couch Sentry: This newly claimed feature enables the user to see and hear (on their SYOR System HDTV) who is at the door before opening it. It works whenever the SYOR System HDTV is turned on, utilizing a wireless outdoor camera. If a knock is heard at the front door, the user simply clicks a button on the TV's remote control. Since the majority of American homes already have the TV turned on after 6:00 pm, this feature is especially useful at night. Statistics show that in most home invasions and robberies, the assailant enters the home through the front door! Opening a door to strangers, particularly at night, is never a good idea. If a mother and children are home alone it's especially unwise. How can families protect themselves? The Couch Sentry. This feature could be particularly valuable to latchkey kids, senior citizens, single moms, etc., to help prevent home invasions and robberies. Additional cameras (available from the company) can monitor the baby's room, driveway, garage, backyard, etc. The Couch Sentry can be marketed as an invaluable home security tool.
SYOR System Website Zip Code Page: This is a new page of my invention's website which requires the user to enter his/her zip code in order to continue to the rest of the website. This zip code information is linked to a database of company store locations throughout the U.S. When a SYOR System website audio ad plays, the second page of this ad displays the retail location (by zip code) of the store which is closest and therefore most convenient for the consumer to purchase the product.
Company Owned TV and Radio Channels (Webcasts): This new claim proposes the establishment of online radio and television channels to be owned and operated by the company which purchases my invention. By acquiring The SYOR System, the company would already have its own radio and TV networks, so this makes sense. These channels could feature 24 hour rotating infomercials for company goods and services. These channels can also offer informative presentations by The SYOR System Advisor.
SYOR System's “Paga Aquf, Toma Alli” (Pay for it here, pick it up there) service: In the Hispanic community, gift giving is very popular, especially at Christmas. Immigrant US workers could virtually send home gifts (toys and electronics) from a U.S. retail chain store by choosing and paying for the gift in one of the store's U.S. locations. Payment can be made by credit card via the SYOR System website or by paying cash. An identical gift may then be picked up by the recipient at an affiliated chain store location in Mexico or Latin America. Advantages of this SYOR System feature include:
Immediate receipt of the gift in Mexico or Latin America.
The gift-giver does not have to package the gift, take it to a Post office, pay for freight, insurance, etc.
There is no possibility of theft along the way.
This service could foster long term relationships between these new US residents, their families in Mexico and Latin America and the retail chain store.
The SYOR SYSTEM Money Transfer Service: The USA's fastest growing ethnic group is Hispanic immigrants. Mexico is the largest contributor to this group; 67% according to the US Census Bureau. Most of these immigrants transfer money (called remittances) home to Mexico and Latin America weekly. In 2005, remittances became Mexico's primary source of income, surpassing the amount of money Mexico makes on oil exports. The SYOR System Money Transfer Service would be most effective if my invention were purchased by a multi-national company such as RadioShack. This company has store locations in Mexico and throughout Latin America. A company like this is ideally positioned to participate in this growing remittance industry. The purchaser could utilize the SYOR System Money Transfer Service in any of these ways:
Utilizing the SYOR System website, credit cards may be used to transfer remittances from the sender in the U.S. to the receiver in Mexico or Latin America.
The company could obtain a Western Union Franchise
The company could obtain a US bank
Individuals could transfer money internationally from store to store.
For companies with stores in Latin America, offering a money-transfer service would accomplish several feats:
Provide a new revenue source for the company
Bring new customers into the company's stores, many for the first time, introducing them to the store's products
Promote the awareness of the company's presence in Mexico and Latin America.
Immediate revenue potential: On a typical $300.00 Western Union money transfer, the fee earned is $5.00 per transaction. If the transfer is done in-house, (Company store on each end, no Western Union involvement) the fee earned is $14.00. Perhaps most important, the money transfer service could initiate a long term relationship between these new US residents, their families in Mexico and the company. By implementing the SYOR System Money Transfer Service, the company will strengthen its Southward expansion. This financial service could open the door for additional future financial services such as credit cards, consumer lending, mortgages, auto loans, etc. Today's money sender may be tomorrow's consumer electronics buyer.

7. This new claim is a security device that has been built into the SYOR System's TV set. Its purpose is to detect the entry of people into the TV's room or home and then call a pre-programmed telephone number to alert the user that someone has entered the TV's room or home. After the call is completed, the system can re-arm itself. This device is composed of:
1. A standard, home security type motion sensor utilizing passive infrared technology (PIR) which detects changes in a room's variable temperatures due to motion in the room.
2. A standard telephone circuitry board with memory (redial feature) which is capable of calling the last number manually dialed when alerted to do so by the motion sensor.
3. A standard small condenser microphone which allows the user to hear what is going on in the room for a time range of from 10 seconds up to one minute.
By listening in on the activity and conversations in the room, the user can determine if the entry is by an intruder (burglar etc.) or a family member. This TV security feature can help protect families from intruders and thieves who may try to enter the home.
